(19) United States
(12) Patent Application Publication
(10) Pub. No.: US 2011/0254913 A1
(43) Pub. Date: Oct. 20, 2011

(54) CONFERENCING APPARATUS AND COMMUNICATION SETTING METHOD

(75) Inventor: Naoyuki Mochida, Tokyo (JP)

(73) Assignee: PANASONIC CORPORATION, Osaka (JP)

(21) Appl. No.: 13/141,426

(22) PCT Filed: Dec. 17, 2009
(86) PCT No.: PCT/JP2009/006993

§ 371 Date: Jun. 22, 2011

(30) Foreign Application Priority Data
Dec. 24, 2008 (JP) P2008-328481

(51) Int. Cl. H04N 7/14

(52) U.S. Cl. 348/14.08; 348/E07.077

(57) ABSTRACT

A conferencing apparatus that is adapted to facilitate a video conference includes a first address information acquisition unit that acquires address information of a first processing terminal device which is connected to a first conferencing apparatus via a first local area network, a first address information notification unit that notifies both the address information of the first conferencing apparatus and the address information of the first processing terminal device to a second conferencing apparatus currently communicating with the first conferencing apparatus, and a first address information reception unit that receives at least address information of the second conferencing apparatus transmitted from the second conferencing apparatus. When the first conferencing apparatus receives a request message of start of sharing from the first processing terminal device, the first address information acquisition unit of the first conferencing apparatus acquires address information, and the first address information notification unit performs notification of the acquired address information. Therefore, conference materials can be output on display devices of the respective processing terminal devices of the participants in the video conference without requiring high level setting of the network. In addition, other participants can carry out interactive operations with respect to a material which is presented by a participant.

### TECHNICAL FIELD

The present invention relates to a conferencing apparatus for performing a video conference via a network, and a communication setting method, and particularly relates to the conferencing apparatus and the communication setting method that enable sharing of a material by using processing terminal devices of users who use the conferencing apparatus and the communication setting method.

### BACKGROUND ART

In the past, a video picture which is transmittable or receivable by a conferencing apparatus used for a video conference or the like via a network has had a low bit rate and a low resolution. However, in the recent years, by virtue of improvement of a throughput of a network, a performance of a semiconductor device and the like, a conferencing apparatus has been able to handle a high vision video picture having a high resolution.

In such circumstances, a system is desired that can present, to a participant, a material such as a video picture, an image, a document or the like which is activated on a processing terminal device such as a personal computer or the like similar to a video picture of a camera by a user who is participating in a video conference. A method of achieving the above system is described below. For example, when a VIG output terminal of a processing terminal device is connected to a VGA input terminal of a conferencing apparatus, display screen data of the processing terminal device is transmitted to the conferencing apparatus. The conferencing apparatus encodes the display screen data in the same manner as for video picture data of a camera, and transmits it to a conferencing apparatus at a counterpart side via a network. The conferencing apparatus at the counterpart side decodes the encoded display screen data to display it on a display device. At that time, the screen of the processing terminal device is displayed on the display device of the conferencing apparatus at the counterpart side as it is.

However, when the above method is used, it is necessary that, as described in the above, the VGA output terminal of the processing terminal device and the VGA input terminal of the conferencing apparatus are connected with a cable. The number of VGA input terminals provided in the conferencing apparatus is usually one. Therefore, in a case where different materials are presented to a counterpart party from a plurality of processing terminal devices, respectively, during a video conference, the cable should be reconnected to another processing terminal device. The handling of the cable is troublesome to the user.

In order to eliminate such a troublesome operation, it is possible to provide a method in which processing terminal devices and a conferencing apparatus are connected to each other via a local area network (LAN), and an application capable of transmitting display screen data of a processing terminal device is executed on each of the processing terminal devices. FIG. 6 is a schematic view showing an example of a video conference system. As shown in FIG. 6, display screen data is respectively transmitted from a plurality of processing terminal devices 15A and 15B to a conferencing apparatus 11A via a local area network 13A. The conferencing apparatus 11A encodes display screen data selectively designated from display screens of the plurality of processing terminal devices 15A and 15B and transmits the encoded data to the counterpart conferencing apparatus 11B via the local area network 13A and a wide area network (WAN) 10. Consequently, in accordance with the above method, the display screen to be transmitted to the counterpart conferencing apparatus 11B can be switched without being limited by the number of VGA input terminals of the conferencing apparatus 11A nor requiring reconnection of a cable. When the local area network is constituted by a wireless communication network, a troublesome operation of connecting LAN cables can be avoided.

In the method described with reference to FIG. 6, the display screen of the processing terminal device is displayed on a display device 12B of the counterpart conferencing apparatus 11B. However, a user of the counterpart conferencing apparatus 11B cannot carry out an interactive operation such as editing of a material displayed on the display device 12B. That is, participants in the conference can share the material from a view point of browsing, but cannot share the material from a view point of editing. In the above method, while the display screen of the processing terminal device is displayed on the display device 12B of the conferencing apparatus 11B, it is not displayed on display devices of other processing terminal devices 15C and 15D. Therefore, in a case where, for example, only the display device 12B of the conferencing apparatus 11B is placed at a front portion of a large conference room, it is hard for a participant who sits at a rear portion of the conference room to watch a video picture on the display device 12B.

The above disadvantage can be solved by establishing a VPN (Virtual Private Network) between routers connecting to the wide area network. FIG. 7 is a schematic view showing an example of a video conference system with the use of the VPN. As shown in FIG. 7, the VPN is established between routers 27A and 27B functioning as gateways of local area networks 23A and 23B. A conferencing apparatus and a plurality of processing terminal devices of users who use the conferencing apparatus are connected to each of the local area networks. At that time, each of the conferencing apparatuses and each of the processing terminal devices are under a condition that they are virtually connected to an identical local area network. Therefore, each of the conferencing apparatuses and each of the processing terminal devices can be connected to another conferencing apparatus and another processing terminal device via the local area networks 23A and 23B, and the wide area network 20 established as the VPN.

Thus, by establishing the network as in the above, a participant in the conference can carry out an interactive operation such as an editing operation or the like of a material stored in another users processing terminal device. In addition, a participant in the conference can watch or listen a video capture of a camera on the display device of the processing terminal device and can browse or edit a material presented by another processing terminal device. Consequently, even in a video conference in a large conference room, participants can participate in the video conference without disadvantages.

### CITATION LIST

Patent Literature
Patent Literature 1: JP-A-2002-64725

### SUMMARY OF INVENTION

### Technical Problem

In the method with the use of a local area network as described in the above, there is the problem that a user of the counterpart conferencing apparatus 11B cannot carry out an interactive operation such as an editing operation or the like of a material displayed on the display device 12B. In addition, there is the problem that a material displayed on the display device 12B is not displayed on display devices of other processing terminal devices 15C and 15D.

In the method with the use of the VPN as described in the above, it is necessary to set the VPN between routers so as to enable communications between each of the conferencing apparatuses and each of the processing terminal devices. Setting of the VPN is generally a work having a high degree of difficulty. Therefore, the work has to be done by only a network manager. Since it is necessary to carry out the setting of the VPN by each conferencing apparatus, the setting of “N×(N−1)” VPNs has to be done with respect to the number N of conferencing apparatuses. Further, when the network manager carries out the setting of each of the VPNs, the network manager has to carry out individual setting as to which processing terminal device is connected to the VPN. Thus, the setting of the VTNs requires extraordinary time and labor. Therefore, a system is desired that gives a good effect without requiring high level setting such as setting of the VPN.

In the setting by the method with the use of the VPN, a participant in the conference or a person not participating in the conference can perform the communication as long as they use apparatuses connected to the local area network. However, the above condition is not preferable from a viewpoint of security.

A purpose of the invention is to provide a conferencing apparatus that can output a material to a display device of each of processing terminal devices used by respective participants in a conference and can allow a participant to carry out an interactive operation to a material presented by another participant without requiring high level setting of a network, and a communication setting method therefor regarding a video conference via a network.

### Solution to Problem

A conferencing apparatus according to the invention is connected to a network and is adapted to perform a video conference between at least two locations via the network. The conferencing apparatus includes a first address information acquisition unit that acquires address information of a predetermined first processing terminal device which is connected to a first conferencing apparatus via a first local area network, a first address information notification unit that notifies the address information of the first conferencing apparatus and the address information of the first processing terminal device to at least one second conferencing apparatus which is during communication with the first conferencing apparatus, and a first address information reception unit that receives at least address information of the second conferencing apparatus transmitted from the second conferencing apparatus. When the first conferencing apparatus receives a request message of start of sharing from the first processing terminal device, the first address information acquisition unit of the first conferencing apparatus acquires address information and the first address information notification unit performs notification of the acquired address information.

A communication setting method according to the invention is adapted to perform a video conference between at least two locations via a gateway and a network. The communication setting method includes an address information acquisition step of acquiring address information of a predetermined processing terminal device connected to a first conferencing apparatus via a local area network, an address information notification step of notifying address information of the first conferencing apparatus and address information of the processing terminal device to at least one second conferencing apparatus which is during communication with the first conferencing apparatus, an address information reception step of receiving at least address information of the second conferencing apparatus transmitted from the second conferencing apparatus, and a gateway control step of performing setting of the gateway to which the first conferencing apparatus is connected via the local area network, so as to cause the first conferencing apparatus, the processing terminal device and the second conferencing apparatus to be in mutually communicable states by using the address information of the first conferencing apparatus, the address information of the processing terminal device acquired in the address information acquisition step, and the address information of the second conferencing apparatus received in the address information reception step.

### Advantageous Effects of Invention

In accordance with the conferencing apparatus and the communication setting method according to the invention, the address information of the processing terminal device can be acquired when sharing is started, and accessing to the processing terminal device from the conferencing apparatus by using a protocol such as a VNC or the like enables interactive operations.

In addition, in accordance with the conferencing apparatus and the communication setting method according to the invention, in a video conference via a network, a material can be output on the display device of each of the processing terminal devices of the respective participants in the conference, and interactive operations to a material presented by a participant can be carried out by another participant without requiring high level setting of the network.

### BRIEF DESCRIPTION OF DRAWINGS

FIG. 1 is a block diagram showing an example of a video conference system according to an embodiment of the invention.

FIG. 2 is a block diagram showing an inner structure of a conferencing apparatus 101 and a part of the video conference system shown in FIG. 1.

FIG. 3 is an explanatory view showing an example of configurations set to routers.

FIG. 4 is a diagram showing an example of a sequence at a time when a video conference using conferencing apparatuses 101A and 101C is started.

FIG. 5 is a diagram showing an example of a sequence at a time when a video conference using the conferencing apparatuses 101A and 101C is started and a request of sharing a material is issued from a processing terminal device during the video conference.

FIG. 6 is a block diagram showing an example of a video conference system.

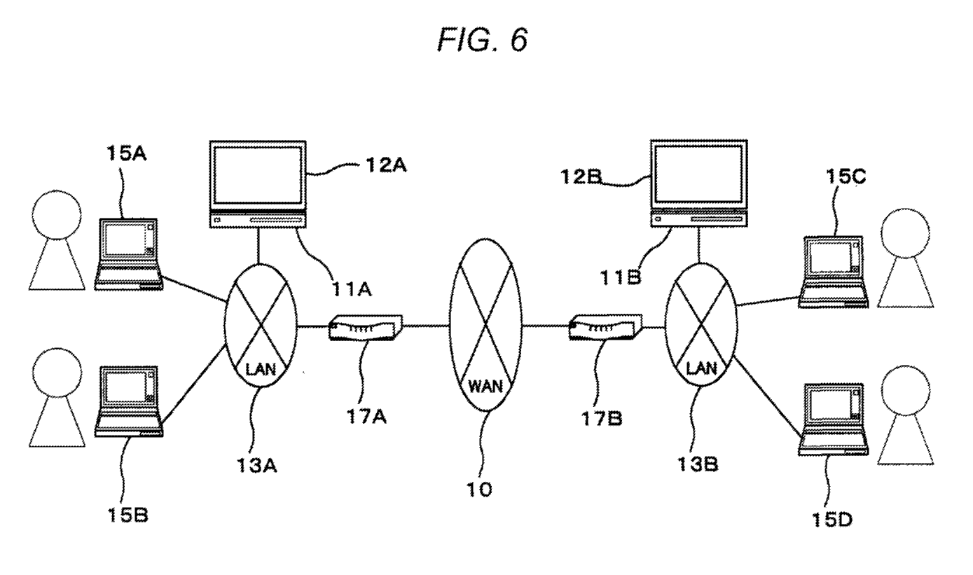

FIG. 7 is a block diagram showing an example of a video conference system with the use of a VPN.

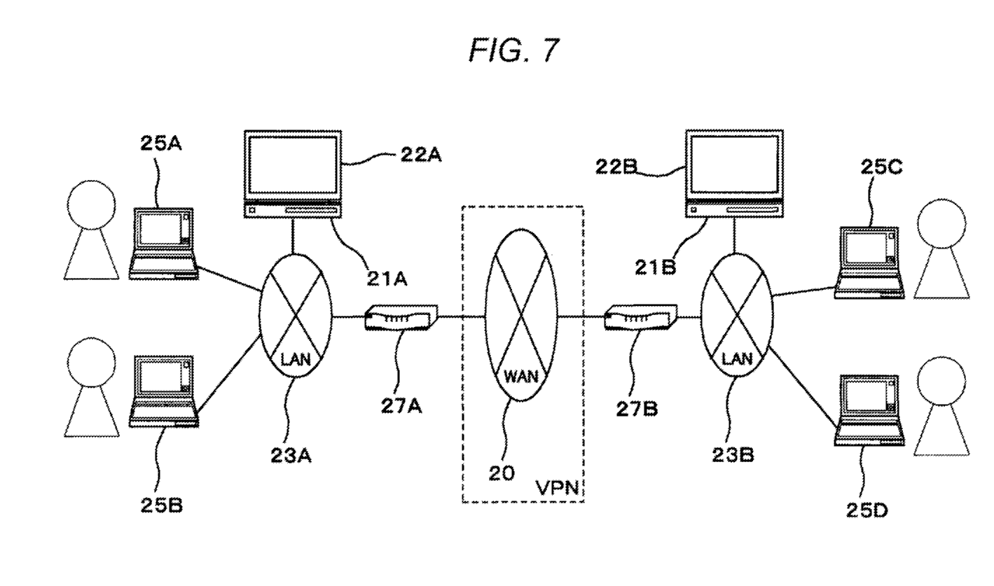

### DESCRIPTION OF EMBODIMENTS

Embodiments according to the invention are described with reference to drawings.

### First Embodiment

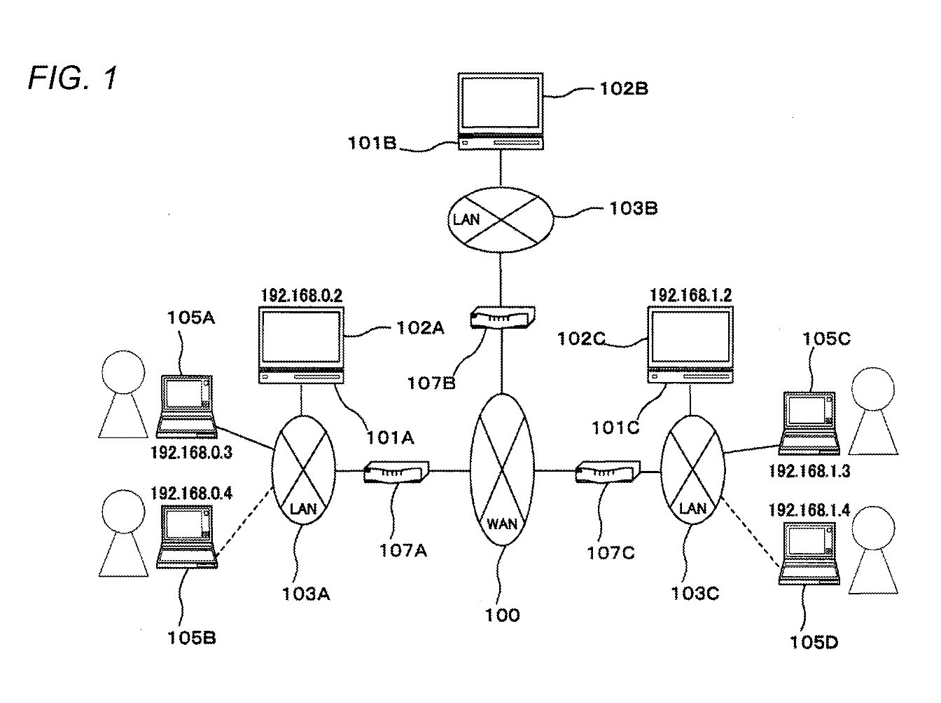

FIG. 1 is a block diagram showing an example of a video conference system including a conferencing apparatus according to an embodiment of the invention. The video conference system is adapted to perform a video conference between at least two locations via a network. The video conference system shown in FIG. 1 includes a wide area network (WAN) 100 such as the Internet or the like, routers 107A, 107B and 107C, local area networks (LANs) 103A, 103B and 103C, conferencing apparatuses 101A, 101B and 101C, display devices 102A, 102B and 102C, and processing terminal devices 105A, 105B, 105C and 105D such as personal computers or the like.

The routers 107A, 107B and 107C are mutually connected via the wide area network 100. The routers are connected to the respective different local area networks. Each of the routers functions as a gateway of the connected local area network. The conferencing apparatuses are connected to the respective local area networks. The display devices are connected to the respective conferencing apparatuses. The processing terminal devices can be connected to the respective predetermined local area networks.

In the example shown in FIG. 1, the router 107A, the conferencing apparatus 101A, and the processing terminal devices 105A and 105B are connected to the local area network 103A. The router 1076 and the conferencing apparatus 101B are connected to the local area network 103B.

The router 107C, the conferencing apparatus 101C and the processing terminals 105C and 105D are connected to the local area network 103C. In the example shown in FIG. 1, a user of the processing terminal device 105A and a user of the processing terminal device 105C are participants in the video conference, and a user of the processing terminal device 105B and a user of the processing terminal device 105D are not participating in the video conference.

Structural components constituting the video conference system shown in FIG. 1 are described below. Each of the routers 107A, 107B and 107C has a function of relaying or transmitting only a packet from a permitted transmission source and a packet to a permitted transmission destination, or a function of NAT (Network Address Transmission). Each of the routers 107A, 107B and 107C can be substituted by a device having a packet filtering function and an access limiting function. A typical router limits access to an external network such as the Internet or the like from a local area network so as to only permit browsing of a web page or using of an electronic mail, but not to permit access to a local area network from an external network.

Each of the processing terminal devices 105A, 105B, 105C and 105D has a transmission/reception unit and an output unit (not shown). The transmission/reception unit performs transmission or reception of data via the network. The output unit displays a video picture or an image or output a sound in accordance with a kind of each of data stored in the own terminal device and data received via the network.

The conferencing apparatuses 101A, 101B and 101C are respectively adapted to perform a video conference between at least two locations. Each conferencing apparatus is provided with the display device, a camera (not shown), a speaker (not shown) and a microphone (not shown). Each conferencing apparatus can be provided with an input interface such as a keyboard, a mouse, a remote controller or the like. Further, each conferencing apparatus is provided with a reception unit that receives data transmitted from another conferencing apparatus or another processing terminal device, and an output unit that outputs the data received by the reception unit. Hereinafter, the conferencing apparatuses 101A, 101B and 101C are collectively referred to as the “conferencing apparatus 101”.

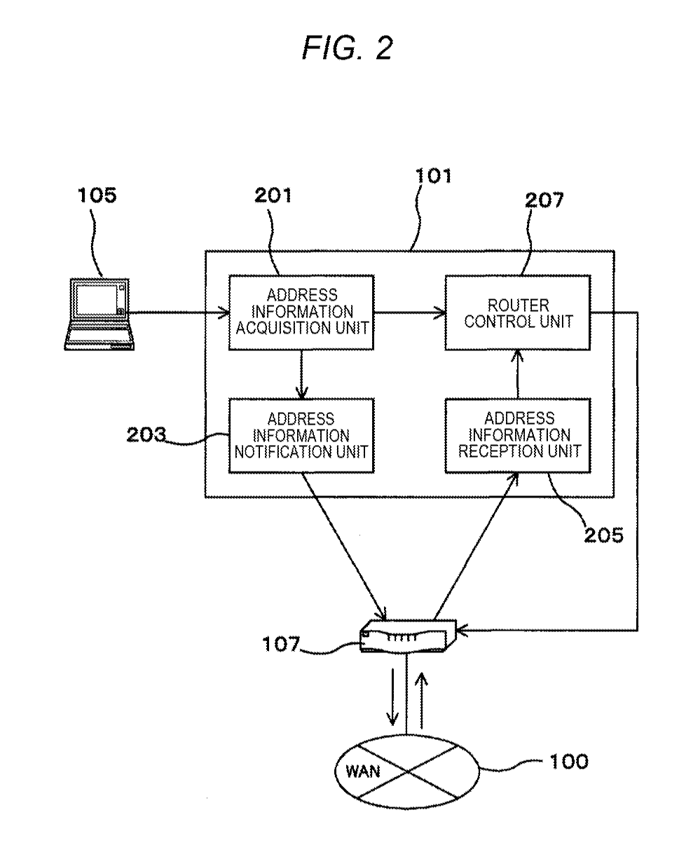

FIG. 2 is a block diagram showing an inner structure of the conferencing apparatus 101 and a part of the video conference system shown in FIG. 1. In FIG. 2, for convenience, indication of a local area network is omitted. As shown in FIG. 2, the conferencing apparatus 101 has an address information acquisition unit 201, an address information notification unit 203, an address information reception unit 205 and a router control unit 207.

The address information acquisition unit 201 acquires address information of the processing terminal device 105 of a user using the conferencing apparatus 101. The address information includes an IP address and a host name. Meanwhile, the address information may include a port number of transmission or reception set in the processing terminal device. The address information acquisition unit 201 transmits the acquired address information to the address information notification unit 203 and the router control unit 207.

The acquisition of the address information by the address information acquisition unit 201 is performed by a predetermined method selected from the following methods (1) to (3):

(1) a method of acquiring address information of a predetermined processing terminal device set in the address information acquisition unit 201;

(2) a method of acquiring address information of a processing terminal device designated by a user (a participant of a video conference) who uses the conferencing apparatus 101 when the video conference is started; and

(3) a method of acquiring, address information of a processing terminal device in such a manner that the conferencing apparatus 101 sends an inquiry to devices connected to the local area network by broad casting or multi-casting and then the conferencing apparatus 101 acquires the address information in accordance with the response content.

The address information acquisition unit 201 may receive a request message of start of sharing transmitted from the processing terminal device. The address information acquisition unit 201 performs an operation of acquiring address information when receiving the request message of start of sharing. It is preferable that the request message of start of sharing may be received by the address information acquisition unit 201 during a conference or upon starting of the conference.

In a case where the conferencing apparatus 101 is utilized by a plurality of users and the plurality of users respectively use the processing terminal devices, the address information acquisition unit 201 acquires the respective address information of the plurality of processing terminal devices. A device to be connected is not limited to the processing terminal device such as a personal computer or the like as long as the device may be connected to the conferencing apparatus 101 and the processing terminal device 105 via network so as to be communicable therewith.

The address information notification unit 203 notifies another conferencing apparatus of the address information of the processing terminal device acquired by the address information acquisition unit 201 and the address information of the conferencing apparatus 101. When the conferencing apparatus 101 notifies another conferencing apparatus of the address information, the address information such as an IP address or the like of the another conferencing apparatus is necessary. While a video conference is held, the conferencing apparatus 101 can acquire address information of another conferencing apparatus in accordance with a call control protocol at a time when the conferencing apparatus 101 starts facilitating of the video conference. Even before the start of the video conference, the address information can be acquired in such a manner that the address information of the another conferencing apparatus is designated by a user via the conferencing apparatus 101. Particularly, when the conferencing apparatus 101 holds an address list, it is possible to designate another conferencing apparatus by a simple operation of the user.

Information indicative of whether it is of the conferencing apparatus or of the processing terminal device may be included in the address information to be notified by the address information notification unit 203. That is, the address information of the conferencing apparatus 101 may include information indicating that it is relating to the conferencing apparatus and the address information of the processing terminal device may include information indicating that it is relating to the processing terminal device.

The address information notification unit 203 inputs address information to a call control message such as an SIP (Session Initiation Protocol) or the like and notifies another conferencing apparatus of the address information as the call control message. The notification of the address information is not limited to the call control message, but the address information may be included in another message between the conferencing apparatuses or notified by a message dedicated for notification of an address.

The address information reception unit 205 receives the call control message such as the SIP or the like so as to receive address information of another conferencing apparatus transmitted from the another conferencing apparatus and address information of the processing terminal device of the user who uses the another conferencing apparatus, the address information being included in the call control message. The address information reception unit 205 transmits the received address information to the router control unit 207.

The router control unit 207 updates a configuration of the router 107 so as to enable mutual communication among another conferencing apparatus designated by the address information received by the address information reception unit 205, the processing terminal device of the user who uses the another conferencing apparatus and the conferencing apparatus 101 as an own apparatus. The updating includes setting of a packet transmission and setting of a filtering. Meanwhile, the router control unit 207 performs the setting of the router 107 by using a standard protocol such as a UPnP (Universal Plug and Play), an SNMP (Simple Network Management Protocol) or the like. The router control unit 207 may perform the setting of the router 107 by using its own protocol of the router. It is desired that the router 107 accepts setting of the packet transmission or setting of the filtering only from the conferencing apparatus 101.

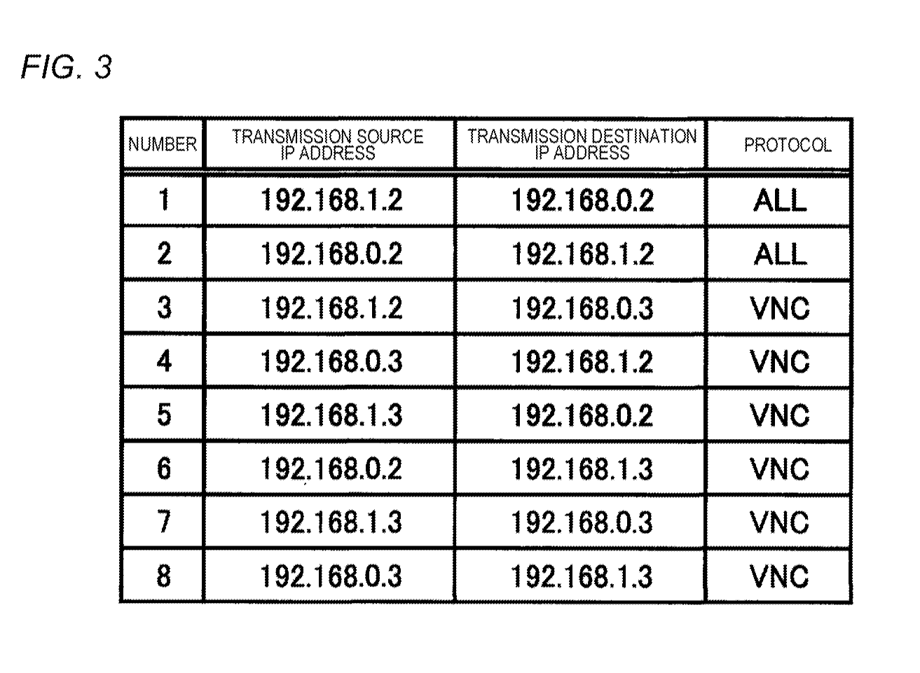

FIG. 3 is an explanatory view showing an example of configurations applied to the routers. IP addresses in FIG. 3 are IP addresses of the conferencing apparatuses or the processing terminal devices shown in FIG. 1. As shown in FIG. 1, the IP address of the conferencing apparatus 101A is set to “192.168.0.2” and the processing terminal device 105A of the user who uses the conferencing apparatus 101A is set to “192.168.0.3”. The address information acquisition unit 201 of the conferencing apparatus 101A acquires the address information of “192.168.0.3” from the processing terminal device 105A. The address information reception unit 205 of the conferencing apparatus 101A receives address information having two IP addresses of “192.168.1.2” and “192.168.1.3” from the conferencing apparatus 101C.

At that time, the router control unit 207 of the conferencing apparatus 101A sets the router 107A so as to enable mutual connections among the apparatuses and devices of four IP addresses. The router control unit 207 of the conferencing apparatus 101C sets, to the router 107C, a relationship between the IP address of the transmission source and the IP address of the transmission destination, the relationship being opposite to that in FIG. 3. In the example shown in FIG. 3, the relationship between the conferencing apparatus 101A and the conferencing apparatus 101C is set to “ALL” so as to enable communication by all of the protocols. In the example, “VNC” in the protocol column means that the communication is set so as to be performed only by the VCN (Virtual Network Computing). The VNC protocol is allowed to communications between the conferencing apparatus 101A and the processing terminal device 105C, between the conferencing apparatus 101C and the processing terminal device 105A, and between the processing terminal devices 105A and 105C. Therefore, only the conferencing apparatuses 101A and 101C and the processing terminal devices 105A and 105C of the participants in the video conference are mutually connected so as to be communicable thereamong.

In the video conference system according to the embodiment, when the above configurations are set to the routers 107A and 107C, the user of the processing terminal device 105A can share a material stored in the processing terminal device 105A with the participants in the video conference. In this case, the user may activate a server software of an application for sharing a material such as the VNC or the like on the processing terminal device 105A. Further, on the conferencing apparatuses 101A and 101C and the processing terminal device 105C, each of the users may activate a client software of an application for sharing a material. After the application of sharing a material is activated on each of the apparatuses and devices, the participants in the video conference can share the material in a style of a video picture, an image or a sound. The VNC protocol is transmitted between the processing terminals 105A and 105C. Consequently, the user of the processing terminal device 105C can edit the shared material by using the processing terminal device 105C.

The router control unit 207 of each of the conferencing apparatuses can set a flow of data relayed by the router to be in a unidirectional or bidirectional fashion as the setting of the packet transmission and the setting of the filtering. In a case where the flow is set in the bidirectional fashion as shown in FIG. 3, not only transmission of the material from the device of a material sharing source to the device of a material sharing destination can be performed, but also communication in the opposite direction can be performed. Therefore, in a case where a material is edited on the device of the material sharing destination, control information based on the editing is transmitted from the device of the material sharing destination to the device of the material sharing source. In a case where the editing of the material on the device of the material sharing destination is to be prohibited, the router control unit 207 sets the flow of data relayed by the router to be in the unidirectional fashion.

### First Embodiment

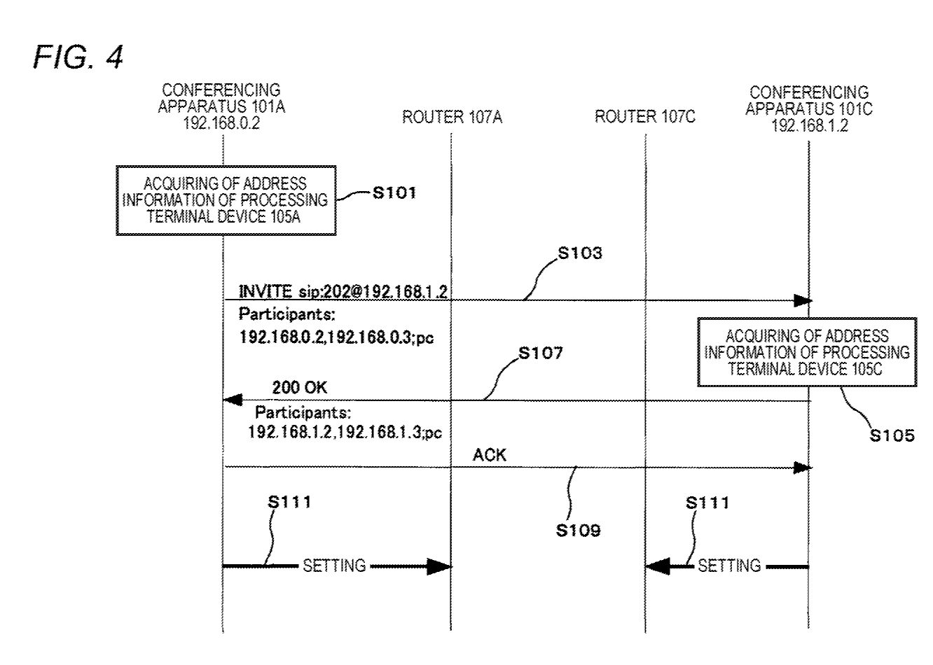

A processing flow at a time when the video conference is started by using the conferencing apparatuses 101A and 101C shown in FIG. 1 is described below with reference to FIG. 4. In the video conference of the embodiment, as a processing terminal device for a user who participates in the video conference by using the conferencing apparatus 101A (IP address: 192.168.0.2), the processing terminal device 105A (IP address: 192.168.0.3) is utilized. In addition, as a processing terminal device for a user who participates in the video conference by using the conferencing apparatus 101C (IP address: 192.168.1.2), the processing terminal device 105C (IP address: 192.168.1.3) is utilized.

FIG. 4 is a diagram showing an example of a sequence at a time when a video conference is started by using the conferencing apparatuses 101A and 101C. When the user of the conferencing apparatus 101A carries out an operation for starting the video conference, the address information acquisition unit 201 of the conferencing apparatus 101A acquires address information of the processing terminal device 105A of the user who holds the video conference by using the processing terminal device 105A (step S101). The process of step S101 may be performed when the conferencing apparatus 101A is activated or when the processing terminal device 105A issues a connection request to the conferencing apparatus 101A via the local area network 103A.

Next, the address information notification unit 203 of the conferencing apparatus 101A transmits “INVITE message” to the conferencing apparatus 101C by using the SIP (step S103). The address information notification unit 203 may use a call control protocol having a function equivalent to that of the SIP such as H.323 or the like. As described below, the INVITE message includes the address information of the conferencing apparatus 101A and the address information of the processing terminal device 105A.

### “INVITE sip:202@192.168.1.2

Participants: 192.168.0.2, 192.168.0.3;pc”

Meanwhile, “192.168.0.3;PC” included in a Participants header in the INVITE message indicates that the device having the IP address of 192.168.0.3 is a PC (a processing terminal device). The conferencing apparatus 101A may set information to be included in the Participants header into a specific XML file, and the address information notification unit 203 may transmits the INVITE message with the XML file attached thereto.

The conferencing apparatus 101C that receives the INVITE message, acquires the address information of the processing terminal device 105C of the user who holds the video conference by utilizing the conferencing apparatus 101C (step S105). The process of step S105 may be performed when the conferencing apparatus 101C is activated.

Next, the address information notification unit 203 of the conferencing apparatus 101C transmits “response message” to the conferencing apparatus 101A by using a predetermined call control protocol (step S107). As described below, the response message includes the address information of the conferencing apparatus 101C and the address information of the processing terminal device 105C.

### “200 OK

Participants: 192.168.1.2, 192.168.1.3;pc”

Meanwhile, “192.168.1.3;PC” included in a Participants header in the response message indicates that the device having the IP address of 192.168.1.3 is a PC (a processing terminal device). The conferencing apparatus 101C may set information to be included in the Participants header into a specific XML file, and the address information notification unit 203 may transmits the response message with the XML file attached thereto.

The conferencing apparatus 101A that receives the response message, transmits “ACK message” as a confirmation response message to the conferencing apparatus 101C (step S109). By the above sequence, a call control session between the conferencing apparatuses 101A and 101C is established. After the call control session is established, the router control unit 207 of each of the conferencing apparatuses performs setting of the packet transmission and the setting of the filtering to the corresponding router connected thereto (step S111). To be specific, the router control unit 207 of each of the conferencing apparatuses performs setting to the corresponding router connected thereto based on the address information included in each of the Participants headers of the INVITE message and the response message. When the setting of the routers is completed, the conferencing apparatuses 101A and 101C and the processing terminal devices 105A and 105C can become in mutually connectable states so that the video conference can be started.

### Second Embodiment

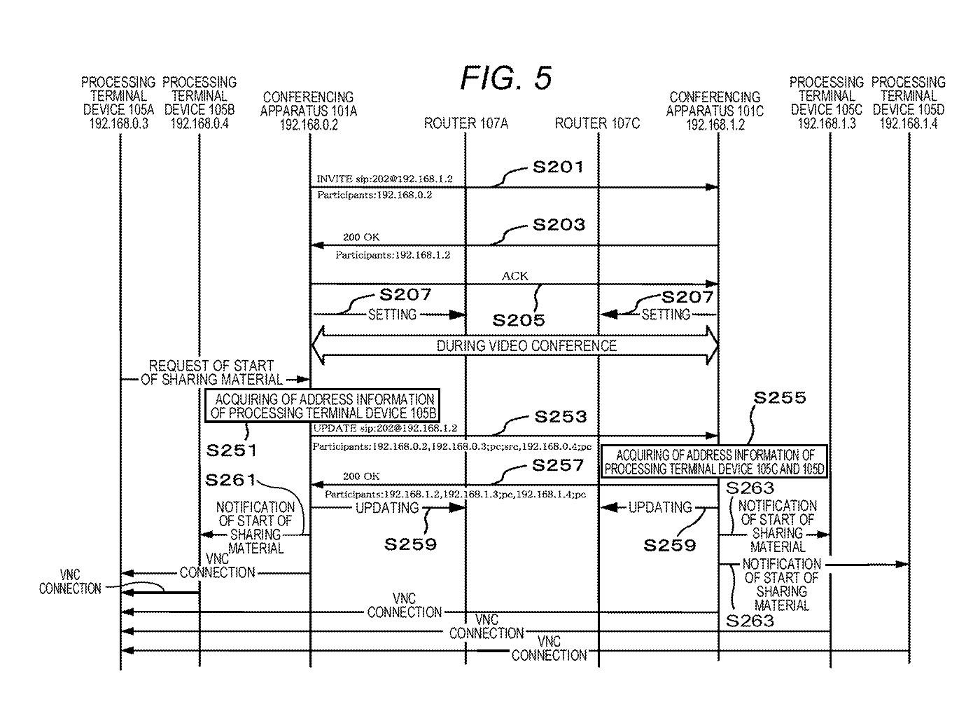

A processing flow at a time when a request of sharing a material is issued from a processing terminal device during a video conference while using the conferencing apparatuses 101A and 101C shown in FIG. 1, is described below with reference to FIG. 5. In the video conference of the embodiment, the video conference is held by using the conferencing apparatus 101A (IP address: 192.168.0.2) together with the processing terminal device of at least one user. As processing terminal devices for users who participate in the video conference, the processing terminal 105A (IP address: 192.168.0.3) and the processing terminal 105B (IP address: 192.168.0.4) are used. In the video conference of the embodiment, the video conference is held by using the conferencing apparatus 101C (IP address: 192.168.1.2) together with the processing terminal device of the user. As processing terminal devices of users who participate in the video conference, the processing terminal 105C (IP address: 192.168.1.3) and the processing terminal 105D (IP address: 192.168.1.4) are used.

FIG. 5 is a diagram showing an example of a sequence at a time when a video conference using the conferencing apparatuses 101A and 101C is started and when a request of sharing a material is issued from the processing terminal device during the video conference. When the user of the conferencing apparatus 101A carries out an operation for starting the video conference, the address information notification unit 203 of the conferencing apparatus 101A transmits “INVITE message” to the conferencing apparatus 101C by using a predetermined call control protocol (step S201). As described below, the INVITE message includes the address information of the conferencing apparatus 101A.

### “INVITE sip: 192.168.1.2

### Participants: 192.168.0.2”

The conferencing apparatus 101C transmits “response message” to the conferencing apparatus 101A in response to the received INVITE message by using a predetermined call control protocol (step S203). As described below, the response message includes the address information of the conferencing apparatus 101C.

### “200 OK

### Participants: 192.168.1.2”

The conferencing apparatus 101A that receives the response message, transmits “ACK message” to the conferencing apparatus 101C (step S205). Next, the router control unit 207 of each of the conferencing apparatuses performs setting of the packet transmission and setting of the filtering to the corresponding router connected thereto (step S207). To be specific, the router control unit 207 of each of the conferencing apparatuses performs setting to the corresponding router connected thereto based on the address information in each of the Participants headers of the INVITE message and the response message. When the setting to the routers is completed, the conferencing apparatuses 101A and 101C can become in mutually connectable states so that the video conference can be started.

A processing flow at a time when the conferencing apparatus 101A receives a request message of start of sharing of a material from the processing terminal device 105A during a video conference, is described below. When a material sharing application is activated on the processing terminal device 105A, the request message of start of sharing of a material is transmitted from the processing terminal device 105A to the conferencing apparatus 101A. In addition, when a wireless LAN adapter including the material sharing application is inserted into the processing terminal device 105A, the request message of start of sharing of a material is transmitted from the processing terminal device 105A to the conferencing apparatus 101A. The request message of start of sharing of a material includes the address information of the processing terminal device 105A.

When the conferencing apparatus 101A receives the request message of start of sharing of a material from the processing terminal device 105A, the address information acquisition unit 201 of the conferencing apparatus 101A acquires the address information of the processing terminal device 105B (step S251). Next, the address information notification unit 203 transmits “update message” to the conferencing apparatus 101C by using a predetermined call control protocol (step S253). As described below, the update message includes the address information of the conferencing apparatus 101A and the address information of the processing terminal devices 105A and 105B.

### “UPDATE sip:202@192.168.1.2

Participants: 192.168.0.2, 192.168.0.3;pc;src, 192.168.0.4;pc”

Meanwhile, “192.168.1.3;pc;src” included in the Participants header in the update message indicates that the device having the IP address of 192.168.1.3 is a PC (a processing terminal device) that issues the request of start of sharing a material.

When the update message is received, the address information acquisition unit 201 of the conferencing apparatus 101C acquires the address information of the processing terminal devices 105C and 105D (step S255). Next, the address information notification unit 203 of the conferencing apparatus 101C transmits the “response message” to the conferencing apparatus 101A by using a predetermined call control protocol (step S257). As described below, the response message includes the address information of the conferencing apparatus 101C and the address information of the processing terminal devices 105C and 105D.

### “200 OK

Participants: 192.168.1.2, 192.168.1.3; pc, 192.168.1.4;pc”

The call control session is updated by the transmission and reception of the update message and the response message. After the call control session is updated, the router control unit 207 of each of the conferencing apparatuses performs setting of the packet transmission and setting of the filtering to the corresponding router connected thereto (step S259). To be specific, the router control unit 207 of each of the conferencing apparatuses updates the configuration of the corresponding router connected thereto based on the address information included in each of the Participants headers of the update message and the response message. When the updating of the configurations is completed, the conferencing apparatuses 101A and 101C and the processing terminal devices 105A, 105B, 105C and 105D can become in mutually connectable states.

Next, the conferencing apparatus 101A transmits a notification message of start of sharing a material including the address information of the processing terminal device 105A to the processing terminal device 105B (step S261). Similarly to the above, the conferencing apparatus 101C transmits a notification message of start of sharing a material including the address information of the processing terminal device 105A to the processing terminal devices 105C and 105D (step S263). Next, the conferencing apparatuses 101A and 101C and the processing terminals 105B, 105C and 105D establish connection to the processing terminal device 105A by the VNC protocol.

Thus, in accordance with the embodiment, it is possible to display a material which is desired to be shared by participants in the video conference, on display devices of the processing terminal devices and the conferencing apparatuses of the respective participants without requiring high level setting of the network such as the VPN or the like. Other participants can carry out interactive operations with respect to a shared material displayed on the display devices of the respective apparatuses and the devices. In addition, since the displaying of the shared material and interactive operations thereto are performed via a specific apparatus or device, it is possible to guarantee the confidentiality of the information. Further, the specific apparatuses or devices can be updated during the video conference.

Meanwhile, when a processing terminal device issues a connection request to a conferencing apparatus, it is possible to request a user to input a password in order to determine whether or not the user of the processing terminal device is an authenticated participant in the video conference. When the password input via the processing terminal device is transmitted to the conferencing apparatus, the conferencing apparatus permits or prohibits participation of the processing terminal device in the video conference in accordance with the password. The conferencing apparatus may allow an identification card such as a USB key containing a password recorded therein to be inserted into the processing terminal device instead of input of a password. When the identification card is inserted into the processing terminal device, the processing terminal device transmits the password recorded in the identification card to the conferencing apparatus.

While the conferencing apparatus and the router are formed to be separated from each other in the example shown in FIG. 1, they may be united. An access point of a wireless LAN may be built in the conferencing apparatus. The conferencing apparatus may authenticate a processing terminal device that establishes connection to the access point as an authenticated processing terminal device which is permitted to participate in the video conference.

While the invention is described in detail by referencing the specific embodiment, it is understood by those of ordinary skill in the art that various modifications and changes can be made without departing from the sprit and scope of the invention.

This application is based on Japanese Patent Application (JP-2008-328481) filed on Dec. 24, 2008, the contents of which are incorporated herein by reference.

### INDUSTRIAL APPLICABILITY

The conferencing apparatus according to the invention is useful for a communication apparatus or the like that connects to a network via a gateway and facilitates a video conference between at least two locations via the network.

### REFERENCE SIGNS LIST

100 Wide Area Network (WAN)
101A, 101B, 101C conferencing apparatus
102A, 102B, 102C display device
103A, 103B, 103C local area network (LAN)
105A, 105B, 105C, 105D processing terminal device
107A, 107B, 107C router
201 address information acquisition unit
203 address information notification unit
205 address information reception unit
   207 router control unit

1. A conferencing apparatus that is connected to a network and is adapted to perform a video conference between at least two locations via the network, the conferencing apparatus comprising:
a first address information acquisition unit that acquires address information of a predetermined first processing terminal device which is connected to a first conferencing apparatus via a first local area network;
a first address information notification unit that notifies the address information of the first conferencing apparatus and the address information of the first processing terminal device to at least one second conferencing apparatus which is during communication with the first conferencing apparatus; and
a first address information reception unit that receives at least address information of the second conferencing apparatus transmitted from the second conferencing apparatus,
wherein when the first conferencing apparatus receives a request message of start of sharing from the first processing terminal device, the first address information acquisition unit of the first conferencing apparatus acquires address information and the first address information notification unit performs notification of the acquired address information.

2. The conferencing apparatus according to claim 1, wherein the second conferencing apparatus includes;
a second address information acquisition unit that acquires address information of a predetermined second processing terminal device which is connected to the second conferencing apparatus via a second local area network;
a second address information notification unit that notifies the address information of the second conferencing apparatus and the address information of the second processing terminal device to the first conferencing apparatus which is during communication with the second conferencing apparatus; and
a second address information reception unit that receives the address information of the first conferencing apparatus and the address information of the first processing terminal device transmitted from the first conferencing apparatus; and
wherein the first address information reception unit receives the address information of the second processing terminal device in addition to the address information of the second conferencing apparatus.

3. The conferencing apparatus according to claim 1, further comprising:
a reception unit that receives data transmitted from another conferencing apparatus, the first processing terminal device or the second processing terminal device; and
an output unit that outputs the data received by the reception unit.

4. The conferencing apparatus according to claim 1, further comprising:
a first gateway control unit that performs setting of a gateway to which the first conferencing apparatus is connected via the first local area network, so as to cause the first conferencing apparatus, the first processing terminal device and the second conferencing apparatus to be in mutually communicable states by using the address information of the first conferencing apparatus, the address information of the first processing terminal device acquired by the first address information acquisition unit and the address information of the second conferencing apparatus received by the first address information reception unit.

5. The conferencing apparatus according to claim 4, wherein the first gateway control unit performs setting of the first gateway so as to cause the first processing terminal device and the second conferencing apparatus to be in mutually communicable states by only a specific protocol.

6. The conferencing apparatus according to claim 4, wherein the second conferencing apparatus includes a second gateway control unit that performs setting of a gateway to which the second conferencing apparatus is connected via the second local area network, so as to cause the first conferencing apparatus, the first processing terminal device, the second conferencing apparatus and the second processing terminal device to be in mutually communicable states by using the address information of the second conferencing apparatus, the address information of the second processing terminal device acquired by the second address information acquisition unit, and the address information of the first conferencing apparatus and the address information of the first processing terminal device received by the second address information reception unit; and
wherein when the first address information reception unit of the first conferencing apparatus receives the address information of the second processing terminal device, the first gateway control unit of the first conferencing apparatus performs setting of the first gateway so as to cause the first conferencing apparatus, the first processing terminal device, the second conferencing apparatus and the second processing terminal device to be in mutually communicable states.

7. The conferencing apparatus according to claim 6, wherein the second gateway control unit performs setting of the second gateway so as to cause the second processing terminal device, the first conferencing apparatus and the first processing terminal device to be in mutually communicable states by only a specific protocol.

8. A communication setting method for performing a video conference between at least two locations via a gateway and a network, the communication setting method comprising:
an address information acquisition step of acquiring address information of a predetermined processing terminal device connected to a first conferencing apparatus via a local area network;
an address information notification step of notifying address information of the first conferencing apparatus and address information of the processing terminal device to at least one second conferencing apparatus which is during communication with the first conferencing apparatus;
an address information reception step of receiving at least address information of the second conferencing apparatus transmitted from the second conferencing apparatus; and
a gateway control step of performing setting of the gateway to which the first conferencing apparatus is connected via the local area network, so as to cause the first conferencing apparatus, the processing terminal device and the second conferencing apparatus to be in mutually communicable states by using the address information of the first conferencing apparatus, the address information of the processing terminal device acquired in the address information acquisition step, and the address information of the second conferencing apparatus received in the address information reception step.
